(19) United States
(12) Patent Application Publication
(10) Pub. No.: US 2024/0031669 A1
(43) Pub. Date: Jan. 25, 2024

(54) IMAGE PROCESSING DEVICE, IMAGE PROCESSING METHOD, AND PROGRAM

(71) Applicant: SONY GROUP CORPORATION, TOKYO (JP)

(72) Inventors: NOBUHIRO TSUNASHIMA, TOKYO (JP); DAISUKE TAHARA, TOKYO (JP)

(21) Appl. No.: 18/257,480

(22) PCT Filed: Nov. 19, 2021
(86) PCT No.: PCT/JP2021/042590

§ 371 Date: Jun. 14, 2023

(30) Foreign Application Priority Data
Dec. 22, 2020 (JP) 2020-212636

(51) Int. Cl. H04N 23/63; H04N 23/80

(52) U.S. Cl. CPC H04N 23/635; H04N 23/632; H04N 23/815

(57) ABSTRACT

An image processing device includes a focus determination unit that generates in-focus determination information obtained by digitizing a degree of in-focus for a specific portion of a subject included in input image data.

### TECHNICAL FIELD

The present technology relates to an image processing device, an image processing method, and a program, and particularly relates to a technology of displaying an image suitable for focus operation of a captured image.

### BACKGROUND ART

When an image is captured by an imaging device such as a still camera or a video camera, an object having a different distance from the camera such as a background may be blurred by focusing on an imaging target. This is because there is an effect of making the imaging target stand out by blurring the background and focusing only on the imaging target.

Methods for focusing are roughly divided into two. The two are manual focusing in which a target subject is focused by an operation of a person (hereinafter, referred to as a user) who operates the camera, and autofocus in which the camera automatically focuses.

In autofocus, the camera automatically performs a focusing operation, but on the other hand, a target desired by a user is not always in focus. Thus, at the time of movie shooting or imaging of image content such as a television broadcast program, manual focus in which the user manually focuses is often used.

Patent Document 1 below discloses a technique of graphically displaying an in-focus evaluation value for manual focus operation in a camera that performs what is called a hill-climbing autofocus (AF).

### CITATION LIST

### Patent Document

Patent Document 1: Japanese Patent Application Laid-Open No. 2007-248615

### SUMMARY OF THE INVENTION

### Problems to be Solved by the Invention

Incidentally, in a case where the user performs manual focus operation with visual checking while capturing an image with the camera, it is necessary to provide an image display device on a camera main body or around the camera main body. A person who operates the camera performs an operation of focusing while looking at a desired target in an image displayed on the display device.

In recent years, the resolution of an image captured by a camera has been refined. The standard of resolution of images of current television broadcasting is mainly 2K (1920×1080 pixels), but broadcasting of 4K (3840×2160 pixels) has started, and imaging of 8K (7680×4320 pixels) has also started.

In contrast, a problem is the resolution of the display device in the camera main body or around the camera main body. As the display device for visual recognition by the user when focusing the camera, in many cases, a large display device cannot be installed, and only a small display device is used due to space issues. Furthermore, even if the display resolution of the small display device mounted on the camera is forcibly increased, it is difficult for human eyes to visually recognize an image in fine details.

For this reason, actually, the display device set in the camera main body or the periphery thereof is often 2K (1920×1080 pixels) or half HD (960×540 pixels) which is half of 2K, or the like. Then, in a case where an image of 4K or more is captured, the resolutions of the image and the display device do not match, and thus the image captured by the camera is reduced in size and displayed on the display device. When the captured image is reduced in size, a detailed portion of the image is collapsed, and consequently, it is difficult to correctly perform focusing.

Furthermore, peaking display is also known as a manual focus assist function. Peaking display is a function of evaluating a degree of focusing from intensity information of an edge portion of an image, and coloring and displaying an edge that is likely to be focused.

However, this peaking display is merely for reference, and an edge portion is colored even though the focus of the position being peaking displayed is not completely aligned, and thus it may be difficult to visually check the portion. Furthermore, since all edges that are likely to be in focus are colored, in a scene with many edges, various positions are colored, and the image may be difficult to see.

Accordingly, the present disclosure proposes an image processing technology that enables monitoring of a captured image in a state suitable for manual focus operation.

### Solutions to Problems

An image processing device according to the present technology includes a focus determination unit that generates in-focus determination information obtained by digitizing a degree of in-focus for a specific portion of a subject included in input image data.

For example, human eyes (pupils) or the like are assumed as a specific portion of a subject that can be a focus target. When there are one or more specific portions in the input image data, the degree of in-focus of the specific portion is digitized. The degree of in-focus is, for example, where the focus corresponds to in a range from a very blurred state to a just focus state.

In the image processing device according to the present technology described above, it is conceivable to include an image combining unit that performs combining processing in which an image based on the in-focus determination information is combined with an image based on the input image data and displayed.

That is, by the combining processing, an image that can be visually recognized in a state where the degree of in-focus is visualized is generated for the specific portion of the subject in the input image data.

In the image processing device according to the present technology described above, it is conceivable that the image combining unit combines through image data obtained by reducing a resolution of the input image data and image data based on the in-focus determination information.

For example, the through image data and the image data based on the combining determination information are combined in such a manner that the image based on the combining determination information is displayed on the through image obtained by reducing a resolution of the captured image.

In the image processing device according to the present technology described above, it is conceivable that the image combining unit performs combining processing in which a numerical value image based on the in-focus determination information is displayed in association with the specific portion.

For example, the degree of in-focus is indicated by displaying a numerical value corresponding to the specific portion of the subject.

In the image processing device according to the present technology described above, it is conceivable that the image combining unit performs combining processing in which an image representing the in-focus determination information by a shape, a color, a luminance, or a gradation is displayed in association with the specific portion.

For example, the degree of in-focus is indicated by displaying a shape representing a numerical value of the in-focus determination information, for example, an image of a bar or the like, corresponding to the specific portion of the subject. Alternatively, an icon or the like in which color, luminance, or gradation changes may be used.

In the image processing device according to the present technology described above, it is conceivable that the image combining unit performs combining processing in which the image based on the in-focus determination information is combined and displayed near the specific portion in the image based on the input image data.

For example, an image expressing the in-focus determination information with a numerical value or a shape is displayed near the specific portion of the subject.

In the image processing device according to the present technology described above, it is conceivable to include a motion detection unit that detects a motion of the specific portion, in which the image combining unit changes a display state of the image based on the in-focus determination information according to a motion detection result of the motion detection unit for the corresponding specific portion.

For example, the reliability of the display content can be expressed by changing the display mode of the in-focus determination information according to the presence or absence of a motion for the specific portion.

In the image processing device according to the present technology described above, it is conceivable that the image combining unit turns off display of the image based on the in-focus determination information for the specific portion in which the motion detection unit detects a motion at a predetermined speed or more.

That is, on/off of display of an image representing the in-focus determination information is switched according to the presence or absence of a motion for the specific portion.

In the image processing device according to the present technology described above, it is conceivable that the image combining unit changes a display mode of the image based on the in-focus determination information for the specific portion in which the motion detection unit detects a motion at a predetermined speed or more.

For example, the color, luminance, gradation, size, shape, and the like of the image representing the in-focus determination information are changed according to the presence or absence of a motion for the specific portion.

It is conceivable that the image processing device according to the present technology described above described above includes a variation information generation unit that generates focus variation information indicating a temporal variation of a degree of in-focus on the basis of the in-focus determination information, and an image combining unit that performs combining processing in which an image based on the focus variation information is combined with an image based on the input image data.

The in-focus variation information is information indicating whether the degree of in-focus has transitioned in a direction to be in focus or a direction to be blurred. By the combining processing, an image in which the focus variation information can be visualized and visually recognized is generated for a specific portion of the subject in the input image data.

In the image processing device according to the present technology described above, it is conceivable that the image based on the focus variation information is an image indicating the temporal variation of the degree of in-focus by a shape, a color, a luminance, or a gradation.

For example, the image is an image expressing whether the degree of in-focus has transitioned in a direction to be in focus or the degree of in-focus has transitioned in a direction to be blurred by an icon, a shape, or the like in which a color, a luminance, or a gradation changes.

Furthermore, in the image processing device according to the present technology described above, it is conceivable that in the image based on the focus variation information, a display form is made different between when a temporal variation of a degree of in-focus is a variation approaching focus and when the temporal variation is a variation moving away from focus.

Furthermore, in the image processing device according to the present technology described above, it is conceivable that in a case where the temporal variation of the degree of in-focus from an in-focus state is equal to or less than a predetermined value, the image based on the focus variation information is in a display form different from a display mode in a case where the temporal variation is a variation approaching focus and a display mode in a case where the temporal variation is a variation moving away from focus.

Thus, the focus variation is expressed in a display form.

In the image processing device according to the present technology described above, it is conceivable that the image combining unit performs combining processing in which a clipped image including the specific portion is combined with the image based on the input image data.

For example, the through image data and the clipped image data are combined in such a manner that a through image obtained by reducing the resolution of a captured image and the clipped image are displayed in one screen. On such a screen, display of an image based on the in-focus determination information and display of an image based on the in-focus variation information are performed.

In the image processing device according to the present technology described above, it is conceivable that the image based on the input image data is a through image obtained by reducing a resolution of the input image data, and the clipped image is an image having a higher resolution than the through image.

For example, a clipping region is set for the input image data, and clipping processing is performed. Alternatively, it is also assumed that clipping is performed from image data obtained by performing enlargement processing on the input image data. Moreover, it is also assumed that clipping is performed from image data obtained by reducing the input image data but having a resolution higher than that of the through image data.

In the image processing device according to the present technology described above, it is conceivable that the in-focus determination information is information based on information obtained by converting image data into a frequency space, logarithmically converting a power spectrum in the frequency space, and further performing an inverse Fourier transform of the power spectrum.

The in-focus determination information based on what is called a cepstrum is obtained.

An image processing method according to the present technology is an image processing method including performing processing of generating in-focus determination information obtained by digitizing a degree of in-focus for a specific portion of a subject included in input image data.

Thus, information indicating the in-focus state is obtained other than the image itself.

A program according to the present technology is a program for causing an arithmetic processing device to execute the processing described above.

Thus, it is possible to easily achieve the image processing device of the present technology.

### BRIEF DESCRIPTION OF DRAWINGS

FIG. 1 is a perspective view of an imaging device on which an image processing device of an embodiment of the present technology can be mounted.

FIG. 2 is a rear view of the imaging device on which the image processing device of the embodiment can be mounted.

FIG. 3 is a block diagram of the imaging device on which the image processing device of the embodiment can be mounted.

FIG. 4 is an explanatory diagram of various mounting modes of the image processing device of the embodiment.

FIG. 5 is a block diagram of an image processing device of a first embodiment.

FIG. 6 is an explanatory diagram of a display example of the embodiment.

FIG. 7 is an explanatory diagram of another display example of the embodiment.

FIG. 8 is a flowchart of a processing example of the first embodiment.

FIG. 9 is a block diagram of an image processing device of a third embodiment.

FIG. 10 is a flowchart of a processing example of the third embodiment.

FIG. 11 is a block diagram of an image processing device of a fourth embodiment.

FIG. 12 is an explanatory diagram of a display example of the fourth embodiment.

FIG. 13 is a flowchart of a processing example of the fourth embodiment.

FIG. 14 is an explanatory diagram of a display example of a fifth embodiment.

FIG. 15 is a block diagram of an image processing device of a sixth embodiment.

### MODE FOR CARRYING OUT THE INVENTION

Hereinafter, embodiments will be described in the following order.
<1. Mounting mode of image processing device>
<2. First embodiment>
<3. Second embodiment>
<4. Third embodiment>
<5. Fourth embodiment>
<6. Fifth embodiment>
<7. Sixth embodiment>
<8. Summary and modification example>

Here, meanings of some terms used in the present disclosure will be described.

An “image” is used as a term including both “still image” and “moving image”.

A “through image” is an image displayed for the imaging person to monitor the subject side. In a device or a system that captures an image, an image (moving image) on the subject side is monitored and displayed for capturing a still image, and monitoring display is also performed while capturing a moving image or during standby of capturing a moving image. In the present disclosure, these are collectively referred to as a through image.

The “through image” refers to an image displayed on a display device, and “through image data” refers to image data for executing display of the through image.

Furthermore, in a case of the embodiment, the “clipped image data” is used particularly for determining a degree of in-focus. The clipped image data is image data obtained by clipping a part of the input image data (or an image based on the input image data). Note that, in a fifth embodiment, an example of displaying the “clipped image” using the “clipped image data” is also described.

### 1. Mounting Mode of Image Processing Device

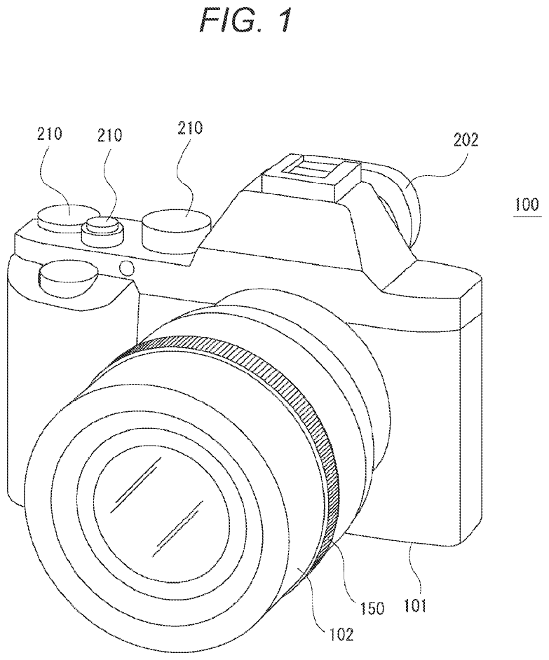

The image processing device 1 of the embodiment performs image processing suitable for display to assist the focus operation of the user, and various mounting modes are assumed for the image processing device 1. First, as an example, a configuration example in a case where the image processing device 1 of the embodiment is mounted on an imaging device 100 will be described with reference to FIGS. 1 to 3.

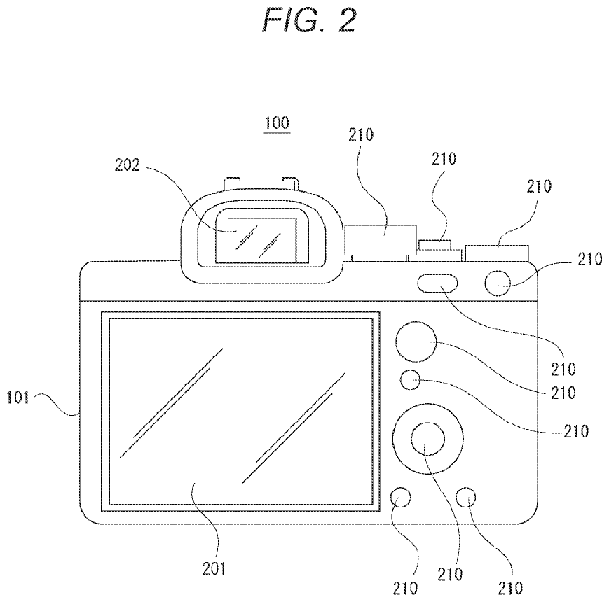

FIG. 1 is a front perspective view of the imaging device 100, and FIG. 2 is a rear view thereof. In this example, the imaging device 100 is what is called a digital still camera, and by switching an imaging mode, both imaging of a still image and imaging of a moving image can be performed.

Note that, in the present embodiment, the imaging device 100 is not limited to the digital still camera, and may be a video camera mainly used for capturing a moving image, a camera capable of capturing only a still image, or a camera capable of capturing only a moving image. Of course, a camera for business use that is used in a broadcasting station or the like may be used.

In the imaging device 100, a lens barrel 102 is disposed on the front side of a main body housing 101 constituting the camera main body.

In a case where the camera is configured as what is called an interchangeable lens camera, the lens barrel 102 is detachable from the main body housing 101, and lenses can be exchanged.

In addition, the lens barrel 102 may not be detachable from the main body housing 101. For example, there are a configuration example in which the lens barrel 102 is fixed to the main body housing 101, and a configuration example as a retractable type that transitions between a state where the lens barrel 102 is retracted and stored on the front surface of the main body housing 101 and a state where the lens barrel 102 protrudes and becomes usable.

The configuration of the imaging device 100 may be any of the above configurations, but the lens barrel 102 is provided with a ring 150 for manual focus operation, for example.

As illustrated in FIG. 2, on a back side (user side) of the imaging device 100, for example, a display panel 201 including a display device such as a liquid crystal display (LCD) or an organic electro-luminescence (EL) display is provided.

In addition, a display unit formed using an LCD, an organic EL display, or the like is also provided as a view finder 202. The view finder 202 is, for example, an electronic view finder (EVF). However, an optical view finder (OVF) may be used, or a hybrid view finder (HVF) using a transmissive liquid crystal may be used.

The user can visually recognize an image and various types of information by the display panel 201 and the view finder 202.

In this example, the imaging device 100 is provided with both the display panel 201 and the view finder 202 but is not limited thereto, and may be provided with only one of the display panel 201 and the view finder 202, or with both or one of the display panel 201 and the view finder 202 being detachable.

Various controls 210 are provided on the main body housing 101 of the imaging device 100.

For example, as the controls 210, various forms such as a key, a dial, and a combined press-rotation control are provided to achieve various operation functions. For example, a shutter operation, a menu operation, a reproduction operation, a mode selection operation, a focus operation, a zoom operation, a selection operation of parameters such as a shutter speed and an F value, and the like can be performed.

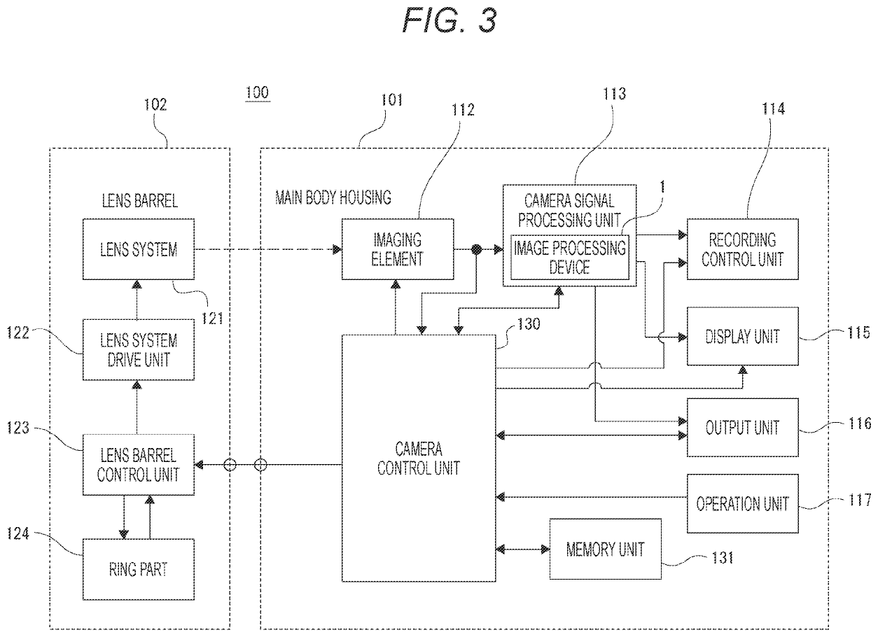

FIG. 3 illustrates an internal configuration of the imaging device 100 including the lens barrel 102. Note that FIG. 3 illustrates an example in which the imaging device 100 is divided into the main body housing 101 and the lens barrel 102.

The imaging device 100 includes an imaging element (image sensor) 112, a camera signal processing unit 113, a recording control unit 114, a display unit 115, an output unit 116, an operation unit 117, a camera control unit 130, and a memory unit 131 in the main body housing 101.

Furthermore, the lens barrel 102 includes a lens system 121, a lens system drive unit 122, a lens barrel control unit 123, and a ring part 124.

The lens system 121 in the lens barrel 102 includes lenses such as a zoom lens and a focus lens, and an iris (diaphragm mechanism). Light (incident light) from a subject is guided by the lens system 121 and condensed on the imaging element 112.

The imaging element 112 is configured as, for example, a charge coupled device (CCD) type, a complementary metal oxide semiconductor (CMOS) type, or the like.

The imaging element 112 executes, for example, correlated double sampling (CDS) processing, automatic gain control (AGC) processing, or the like on an electrical signal obtained by photoelectrically converting received light, and further performs analog/digital (A/D) conversion processing. Then, an imaging signal as digital data is output to the camera signal processing unit 113 and the camera control unit 130 in a subsequent stage.

The camera signal processing unit 113 is configured as an image processing processor by, for example, a digital signal processor (DSP) or the like. The camera signal processing unit 113 performs various types of signal processing on a digital signal (captured image signal) from the imaging element 112. For example, as a camera process, the camera signal processing unit 113 performs preprocessing, simultaneous processing, YC generation processing, resolution conversion processing, codec processing, and the like.

Here, the camera signal processing unit 113 has a function as the image processing device 1. The image processing device 1 described herein generates the through image and performs processing for focus assist. The processing for focus assist refers to processing of generating the in-focus determination information obtained by digitizing the degree of in-focus for a specific portion of a subject in image data, a processing function of generating an image based on the in-focus determination information, combining the image with the through image, and the like.

The configuration and operation of the image processing device 1 will be described later.

The recording control unit 114 performs recording and reproduction on a recording medium by a non-volatile memory, for example. The recording control unit 114 performs processing of recording an image file such as moving image data and still image data, a thumbnail image, or the like on a recording medium, for example.

Various actual forms of the recording control unit 114 can be considered. For example, the recording control unit 114 may be configured as a flash memory built in the imaging device 100 and a write-read circuit thereof, or may be in the form of a card recording-reproducing unit that performs recording-reproducing access to a recording medium that can be attached to and detached from the imaging device 100, for example, a memory card (portable flash memory or the like). Furthermore, it may be implemented as a hard disk drive (HDD) or the like as a form built in the imaging device 100.

The display unit 115 is a display unit that displays various displays to the imaging person, and specifically indicates the display panel 201 and the view finder 202 illustrated in FIG. 2.

The display unit 115 executes various displays on the display screen on the basis of an instruction from the camera control unit 130. For example, the display unit 115 displays a reproduced image of image data read from the recording medium in the recording control unit 114. Furthermore, the image data of the captured image whose resolution has been converted for display by the camera signal processing unit 113 is supplied to the display unit 115, and the display unit 115 performs display on the basis of the image data of the captured image in response to an instruction from the camera control unit 130. That is, through image display is performed.

Furthermore, the display unit 115 causes display of various operation menus, icons, messages, and the like, that is, display as a graphical user interface (GUI) to be executed on the screen on the basis of instructions of the camera control unit 130.

The output unit 116 performs data communication and network communication with an external device by wire or wirelessly. For example, captured image data (still image file or moving image file) is transmitted and output to an external display device, recording device, reproduction device, information processing device, or the like.

Furthermore, assuming that it is a network communication unit, for example, the output unit 116 may communicate with various networks such as the Internet, a home network, and a local area network (LAN), and transmit and receive various data to and from a server, a terminal, and the like on the network.

The operation unit 117 collectively indicates input devices for the user to perform various operation inputs. Specifically, the operation unit 117 indicates the various controls 210 provided in the main body housing 101. The operation unit 117 detects an operation by the user, and a signal corresponding to the input operation is sent to the camera control unit 130.

As the operation unit 117, not only the controls 210 but also a touch panel may be used. For example, a touch panel may be formed on the display panel 201, and various operations may be possible by operating the touch panel using icons, menus, and the like to be displayed on the display panel 201.

Alternatively, the operation unit 117 may also have a mode of detecting a tap operation or the like by the user with a touch pad or the like.

Moreover, the operation unit 117 may be configured as a reception unit of an external operation device such as a separate remote controller.

The camera control unit 130 includes a microcomputer (arithmetic processing device) equipped with a central processing unit (CPU).

The memory unit 131 stores information and the like used for processing by the camera control unit 130. The illustrated memory unit 131 comprehensively indicate, for example, a read only memory (ROM), a random access memory (RAM), a flash memory, and the like.

The memory unit 131 may be a memory area built in a microcomputer chip as the camera control unit 130 or may be configured by a separate memory chip.

The camera control unit 130 controls the entire imaging device 100 and the lens barrel 102 by executing a program stored in the ROM of the memory unit 131, the flash memory, or the like.

For example, the camera control unit 130 controls operation of each necessary part for controlling shutter speed of the imaging element 112, instructing various signal processing in the camera signal processing unit 113, imaging operation and recording operation according to an operation by the user, reproduction operation of a recorded image file, operation of a user interface, and the like. For the lens system 121, the camera control unit 130 performs, for example, autofocus control of automatically focusing on a target subject, change of an F value according to a setting operation of the user, automatic iris control of automatically controlling the F value, and the like.

The RAM in the memory unit 131 is used for temporarily storing data, programs, and the like as a work area for various data processing of the CPU of the camera control unit 130.

The ROM and the flash memory (non-volatile memory) in the memory unit 131 are used for storing an operating system (OS) for the CPU to control each unit, content files such as image files, application programs for various operations, and firmware, and the like.

When the lens barrel 102 is attached to the main body housing 101, the camera control unit 130 communicates with the lens barrel control unit 123 and gives various instructions.

The lens barrel 102 is equipped with, for example, the lens barrel control unit 123 with a microcomputer, and various data communication with the camera control unit 130 is possible. For example, the camera control unit 130 instructs the lens barrel control unit 123 to drive a zoom lens, a focus lens, an iris (diaphragm mechanism), and the like. The lens barrel control unit 123 controls the lens system drive unit 122 in response to these drive instructions to execute the operation of the lens system 121.

The lens system drive unit 122 is provided with, for example, a motor driver for a zoom lens drive motor, a motor driver for a focus lens drive motor, a motor driver for an iris, and the like.

In these motor drivers, a drive current is applied to the corresponding driver in response to an instruction from the lens barrel control unit 123 to perform moving the focus lens and zoom lens, opening and closing diaphragm blades of the iris, and the like.

The ring part 124 includes the ring 150 illustrated in FIG. 1, a rotation mechanism of the ring 150, a sensor for detecting a rotation angle of the ring 150, and the like. In response to detecting the rotation of the ring 150 in the ring part 124, the lens barrel control unit 123 outputs a drive instruction to the lens system drive unit 122 to drive the focus lens.

Note that the above is merely an example of the configuration of the imaging device 100.

Although the image processing device 1 of the embodiment is included in the camera signal processing unit 113 as an example, the image processing device 1 may be configured by software in the camera control unit 130, for example. Furthermore, the image processing device 1 may be configured by a chip or the like separate from the camera signal processing unit 113 and the camera control unit 130.

Furthermore, the imaging device 100 described above includes the image processing device 1 and the display unit 115 including the display panel 201 and the view finder 202, and displays a through image. In addition, the image processing device 1 performs processing of displaying an image for focus assist together with the through image. Accordingly, the imaging device 100 is configured to display the through image and the clipped image on the display unit 115 on the basis of the processing of the image processing device 1.

However, it is also assumed that a through image or a clipped image is displayed on a separate display device.

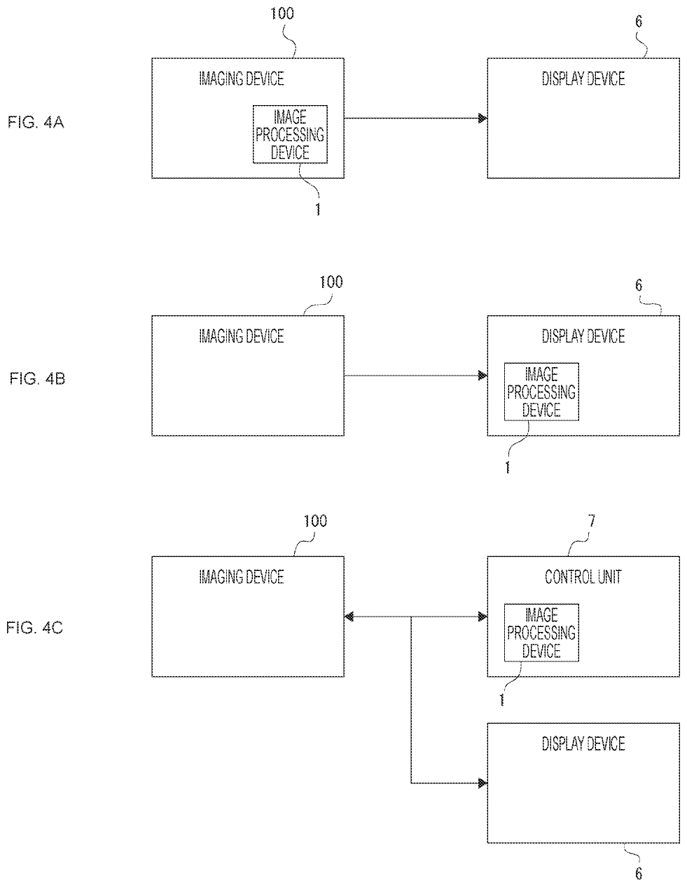

For example, FIG. 4A illustrates a configuration in which a separate display device 6 is connected to the imaging device 100. The imaging device 100 transmits the through image data to the display device 6, so that the through image is displayed on the display device 6, and the user can check the subject on the display device 6.

In a case of such a configuration, the image processing device 1 is provided in the imaging device 100, and the image processing device 1 generates processing of generating the in-focus determination information obtained by digitizing the degree of in-focus for the specific portion of the subject, and combined image data of the through image data and image data based on the in-focus determination information. Then, the combined image data is transmitted to and displayed on the display device 6, so that both the through image and the image for focus assist can be viewed on the display device 6.

Furthermore, as illustrated in FIG. 4B, the image processing device 1 may be provided on the display device 6 side.

That is, the imaging device 100 transmits the captured image data to the display device 6. The display device 6 generates the through image data by performing resolution conversion from the captured image data, generates the in-focus determination information, and generates the combined image data of the image data based on the in-focus determination information. Then, these pieces of image data are displayed. Thus, the user can view both the through image and the image for focus assist on the display device 6.

FIG. 4C illustrates a mode in which the imaging device 100, the display device 6, and the control unit 7 are connected. In this case, an example is conceivable in which the image processing device 1 is provided in the control unit 7. The image processing device 1 generates the through image data, and generates processing of generating in-focus determination information, and the combined image data of the image data based on the in-focus determination information. Then, the combined image data is generated and transmitted to the display device. Thus, the user can see both the through image and the image for focus assist on the display device 6.

Of course, even in a case where the control unit 7 is connected, an example in which the image processing device 1 is provided in the imaging device 100 and an example in which the image processing device 1 is provided in the display device 6 are also conceivable.

Furthermore, although not illustrated, an example is also conceivable in which the image processing device 1 is provided in a cloud server, generates the through image data and image data for focus assist through network communication, and transmits the through image data and the image data or combined image data thereof to the display device 6 for display.

### 2. First Embodiment

Hereinafter, the image processing device 1 of the embodiment will be described in detail.

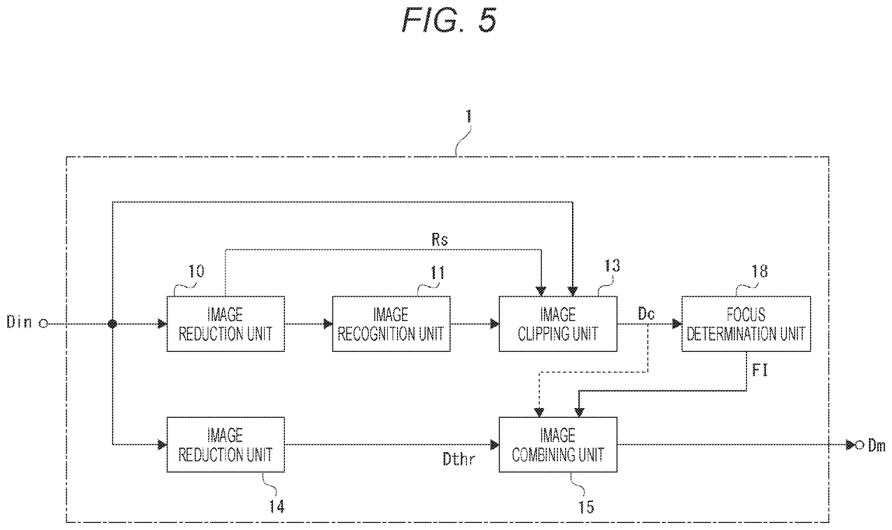

FIG. 5 illustrates a configuration example of the image processing device 1. The image processing device 1 includes an image reduction unit 10, an image recognition unit 11, an image clipping unit 13, an image reduction unit 14, an image combining unit 15, and a focus determination unit 18. These may be configured by software or may be configured by hardware.

Input image data Din is input to the image processing device 1. The input image data Din is, for example, captured image data subjected to development processing in the camera signal processing unit 113 in FIG. 3, and for example, image data before resolution conversion for a through image is assumed. For example, also in a case where the image processing device 1 is mounted in addition to the imaging device 100 as illustrated in FIGS. 4B and 4C, it is assumed that the captured image data is transmitted from the imaging device 100.

As a more specific example, it is assumed that the input image data Din is high-definition image data such as 4K or 8K.

The input image data Din is supplied to each of the image reduction unit 10, the image clipping unit 13, and the image reduction unit 14.

The image reduction unit 10 performs image size reduction processing on the input image data Din. This is because it takes a lot of time if the subject recognition processing of the image recognition unit 11 at the subsequent stage is processed with high-definition image data such as 4K, and an image having a small size such as VGA (640×480 pixels) or QVGA (320×240 pixels) is used by the reduction processing.

Note that the image reduction unit 10 notifies the image clipping unit 13 of a reduction ratio RS in the executed reduction processing.

The image recognition unit 11 performs subject recognition processing on the image reduced by the image reduction unit 10. Specifically, the image recognition unit 11 can recognize a person included in the image as a subject and a face, an eye, a hand, and the like that are parts of a person. In particular, the image recognition unit 11 detects a specific portion of the subject included in the input image data Din and specifies the coordinate position thereof.

Here, the specific portion is a portion to be subjected to in-focus determination and image output for focus assist. It is appropriate that the target for in-focus determination is a portion that can be a focus target. As a specific example, it is assumed to be an eye (pupil) of a person.

Of course, various types of specific portions to be detected may be considered, and may be, for example, a face, a nose, an ear, a mouth, or the like of a person who is a subject, or an eye of an animal other than a person, a portion of a specific shape of an object, a portion of a specific color, or the like.

However, since the specific portion is a portion to be subjected to determination of the degree of in-focus in the subject, it is preferable that the specific portion is a portion of an image containing a high-frequency component. Furthermore, in order to be suitable for comparison of the degree of in-focus, it is desirable that the specific portion is a portion having a shape that is not so different for each subject (for example, person). Specifically, it is preferable that the in-focus determination information to be obtained by the cepstrum as described later hardly varies depending on a person, and an evaluation itself of the focus state is easily reflected.

In that sense, the eye can be evaluated as having many high frequency components and having little difference depending on the person, and is preferable as the specific portion.

Hereinafter, an example in which an eye (right eye) is detected as a specific portion will be described.

For example, deep learning is used to recognize such a subject and detect such a specific portion. Since parts of the human body such as joints of hands and feet, eyes, a nose, and ears can be detected from image data by using a deep learning technology, specific portions among them are detected, and a coordinate position in the image is specified.

For example, in a case where the input image data Din is an image in which there are three subject persons, the right eye of each person is detected as the specific portion, and the coordinate position is specified.

The coordinate position of one or more specific portions detected by the image recognition unit 11 are sent to the image clipping unit 13.

From the coordinate position of the specific portion transmitted from the image recognition unit 11 and the reduction ratio RS transmitted from the image reduction unit 10, the image clipping unit 13 converts the coordinate position of the specific portion into a coordinate position in an image to be subjected to the clipping processing.

In this example, it is assumed that the image clipping unit 13 performs the clipping processing from the input image data Din which is the original image before the reduction processing. Therefore, the image clipping unit 13 converts the coordinate position of the specific portion detected from a reduced image into a coordinate position in the input image data Din.

Then, the image clipping unit 13 performs image clipping processing from the input image data Din with a preset image size centered on the coordinate position of the specific portion.

In a case where coordinate positions of a plurality of specific portions have been sent, the image clipping processing as described above is performed by the number of sent coordinate positions.

Then, the image clipping unit 13 sends one or more pieces of clipped image data Dc to the focus determination unit 18.

The focus determination unit 18 calculates the degree of in-focus of each clipped image data Dc clipped around, for example, the “right eye” in the image clipping unit 13. The degree of in-focus is the degree of focusing.

Generally, an image out of focus is called a blurred image. The blurred image is expressed as a result of convolving a blurring function called point spread function (PSF) with an unblurred image (original image). The PSF becomes gentle when blurred, and becomes steep when not blurred. If the original image and the PSF can be separated from the blurred image, the degree of blurring of the blurred image, that is, the degree of in-focus can be determined.

A method called cepstrum is used to separate the original image and the PSF from the blurred image. The cepstrum is obtained as follows.

Two-dimensional Fourier transform processing is performed on image data as a processing target (clipped image data Dc in a case of the present embodiment) to convert the image data into a frequency space, and a power spectrum in the frequency space is subjected to a logarithmic transform, and is further performing an inverse Fourier transform of the power spectrum. The one created in this manner is called a cepstrum. The cepstrum of the image data is represented by the sum of a cepstrum of original image data and a cepstrum of the blurring function (PSF), and the cepstrum of the original image data is smaller than the cepstrum of the blurred image data, so that the cepstrum of the blurred image data is dominant.

A calculation expression of the cepstrum in a case where the image data as the processing target (for example, the clipped image data Dc) is g, the original image data is f, the PSF is h, the cepstrum of the image data as the processing target is gc, the cepstrum of the original image data is fc, and the cepstrum of the PSF is hc will be described below.

$$gc = {FT}^{- 1} ( log ( \vert FT ( g ) \vert ) {FT}^{- 1} ( log ( \vert FT ( f * h ) \vert ) {FT}^{- 1} ( log ( \vert FT ( F ) \times FT ( h ) ) \vert ) {FT}^{- 1} ( log ( \vert FT ( f ) \vert ) ) + {FT}^{- 1} ( log ( \vert FT ( h ) \vert ) ) fc + hc \qquad [ Mathematical 1 ]$$

FT is a Fourier transform, and FT⁻¹ is an inverse Fourier transform.

In the cepstrum of the image data as the processing target, there remain a small number of cepstrums of the original image data, and thus it is difficult to simply take out only the cepstrum of the blurred image data. However, by limiting the image data as the processing target that is mentioned here to the clipped image data Dc, that is, the image data of the eye region, the cepstrum of the original image data is considered to be similar.

Furthermore, as described above, the original image data, in this case, the cepstrum of the eye region is smaller than the cepstrum of the PSF. Therefore, since the cepstrum of the original image data can be regarded as a very small constant, the degree of in-focus can be obtained from the cepstrum of the eye region.

Contrary to the PSF, the cepstrum becomes steep when the blur is large, and becomes gentle when the blur is small. Therefore, the degree of in-focus is digitized by obtaining a variance or standard deviation of the value of the central portion of the cepstrum of the PSF.

$$σ = {\sum }_{y = yc - 1}^{yc + 1} {\sum }_{x = xc - 1}^{xc + 1} {( gc ( x , y ) - \overline{gc} )}^{2} \qquad [ Mathematical 2 ]$$

σ represents a variance value, and xc and yc represent coordinates of the center of the image.

The variance value may be 3×3 pixels or a larger region.

The variance value increases when a blur occurs, and decreases when a blur does not occur. For example, a calculation expression of the variance of the 3×3 region in the central portion of the image is illustrated below. From the viewpoint of the degree of in-focus, it is visually easy to understand that the larger the numerical value, the more in focus. Accordingly, the variance value of the cepstrum is converted into a numerical value of the degree of in-focus by the following conversion expression.

e=1−√σ [Mathematical 3]

The focus determination unit 18 sets, for example, the numerical value of the degree of in-focus obtained as described above as in-focus determination information FI.

The focus determination unit 18 obtains the in-focus determination information FI for each specific portion, and sends the in-focus determination information FI to the image combining unit 15.

Note that the in-focus determination information FI includes a numerical value of the degree of in-focus and information indicating coordinate values of the specific portion or the range of the clipping region, so that it is possible to recognize which portion of the image the numerical value of the degree of in-focus is for during combining processing in the image combining unit 15.

On the other hand, the image reduction unit 14 also performs reduction processing on the input image data Din. The image reduction unit 14 performs reduction processing for generating through image data Dthr, that is, conversion into low resolution.

Therefore, the through image data Dthr from the image reduction unit 14 and the in-focus determination information FI from the focus determination unit 18 are supplied to the image combining unit 15, and are used to perform combining processing by the image combining unit 15.

For example, the image combining unit 15 generates combined image data Dm obtained by combining the through image data Dthr and image data drawn on the basis of numerical values obtained as the in-focus determination information FI.

The combined image data Dm is sent to a display device (the display device 6, the display panel 201, the view finder 202, and the like) and displayed for the user. Thus, the user can visually recognize an image based on the in-focus determination information FI on the through image.

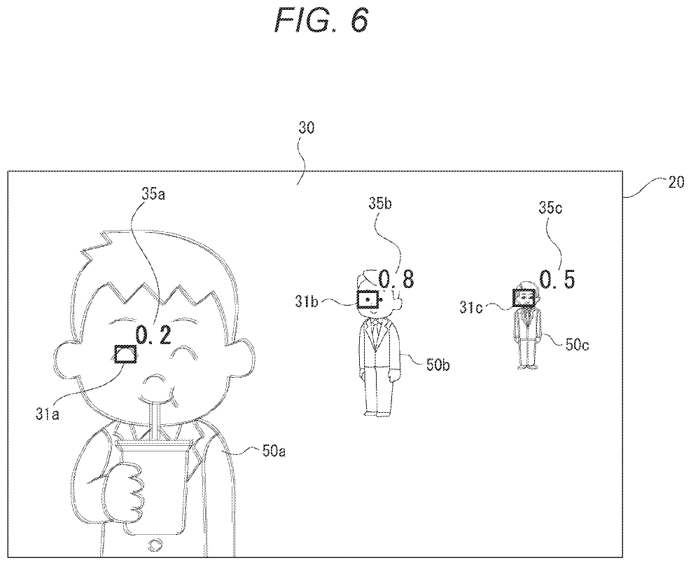

FIG. 6 illustrates a display example. FIG. 6 illustrates a state in which the through image 30 is displayed on the screen of the display device. In this example, it is assumed that persons 50a, 50b, and 50c exist as subjects, the image clipping processing is performed with the right eye of each of the persons 50a, 50b, and 50c as the specific portion, and the in-focus determination information FI of each person is calculated.

On the through image 30, a focus frame 31 (31a, 31b, and 31c) is displayed corresponding to specific portions, and indicates that these portions are possibilities for a focus control target.

Furthermore, FIG. 6 illustrates a state in which the person is most focused, and the person 50a closer to the imaging device 100 and the person 50c farther from the imaging device 100 are blurred images.

In this case, as an image based on the in-focus determination information FI, the in-focus determination value (35a, 35b, or 35c) is displayed near the focus frame 31a, 31b, or 31c of each person 50. By displaying the in-focus determination value 35 near the focus frame 31, it is possible to know which part the displayed numerical value indicates the degree of in-focus.

Note that, for the sake of description, the focus frame, the in-focus determination value, the person, and the like are referred to as a “focus frame 31”, an “in-focus determination value 35”, and a “person 50”, respectively, when collectively referred to, and are identified by adding alphabets such as a “focus frame 31a”, an “in-focus determination value 35a”, and a “person 50a”, respectively, when indicated individually.

Here, the in-focus determination information FI is, for example, a value taking “0.0” to “1.0”, and a numerical values of the calculated in-focus determination information FI are drawn as the in-focus determination values 35a, 35b, and 35c. The in-focus determination values 35a, 35b, and 35c in the drawing are “0.2”, “0.8”, and “0.5”, respectively, and it is presented by a number that the person 50b is the most focused.

Thus, even if the through image 30 is a low-resolution image, the user can clearly recognize the degree of in-focus of each subject.

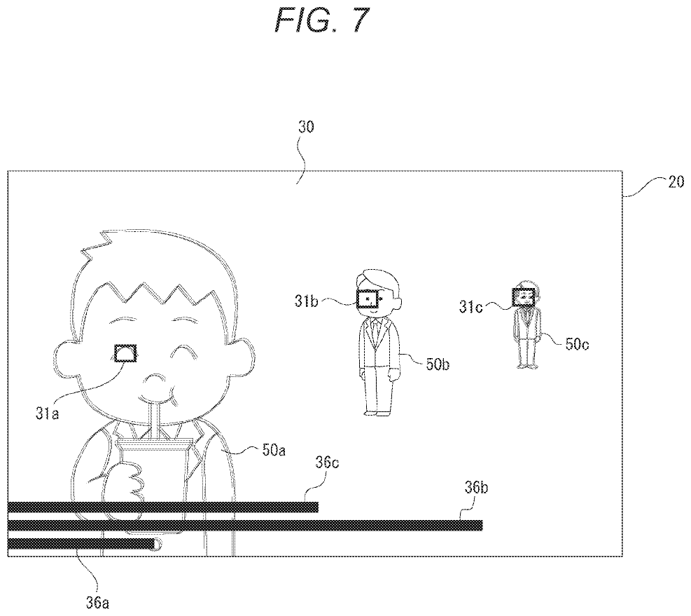

FIG. 7 illustrates another display example.

The image combining unit 15 performs combining processing of drawing a bar-shaped image on the through image 30 on the basis of the in-focus determination information FI. Thus, an in-focus determination bar 36 (36a, 36b, and 36c) is displayed as illustrated in the drawing.

The in-focus determination bar 36 is a bar-shaped image having a length corresponding to the value of the in-focus determination information FI.

Note that the in-focus determination bar 36 is illustrated not near the focus frame 31 but collectively in a lower portion of the through image 30 so as not to interfere with the through image 30 as much as possible.

However, it is necessary to make the correspondence relationship between each in-focus determination bar 36 and the specific portion known.

Accordingly, for example, the correspondence relationship is indicated by color.

For example, by displaying the focus frames 31a, 31b, and 31c in red, green, and blue, respectively, and by displaying the in-focus determination bars 36a, 36b, and 36c in red, green, and blue, respectively, the correspondence relationship is indicated by the same color.

Thus, for example, it is indicated that the longest in-focus determination bar 36b corresponds to the focus frame 31b, and the user can recognize that the person 50b is the most focused.

Of course, the correspondence relationship may be indicated by a method other than color, for example, marker display or the like.

Furthermore, the correspondence relationship can be indicated by a positional relationship. For example, in FIG. 7, the in-focus determination bars 36a, 36b, and 36c are displayed in order from the bottom of the screen 20 corresponding to the persons 50a, 50b, and 50c in order of proximity to the imaging device 100.

Furthermore, assuming that the in-focus determination bar 36 reaches the right end from the left end of the screen 20 in the most focused state, that is, the state of the in-focus determination information FI=“1.0”, the user can intuitively recognize that the in-focus determination bar 36a has a value of about 20%, the in-focus determination bar 36b has a value of about 80%, and the in-focus determination bar 36c has a value of about 50% in the state as illustrated in FIG. 7, for example.

Note that although the in-focus determination bar 36 is used in the example of FIG. 7, an example of graphically displaying the degree of in-focus in another shape such as displaying a circular graph is also conceivable.

In addition, the value of the in-focus determination information may be displayed in such a manner as to be expressed by a change in gradation, luminance, color, size, or the like of an image such as a figure or an icon.

Moreover, display may be performed to express the value of the in-focus determination information by a color, a luminance, or a gradation of the specific portion itself.

Furthermore, in the examples of FIGS. 6 and 7, the degree of in-focus is displayed with only the right eye of the subject person as the specific portion, but in a case where the right eye and the left eye are specific portions and the both eyes are detected, the degree of in-focus may be calculated and displayed for each of both eyes, or only one eye may be displayed with priority given to either eye.

Furthermore, although the image combining unit 15 performs the combining processing and displays the image data, image data based on the through image data Dthr and the in-focus determination information FI may be separately output and displayed on different display devices.

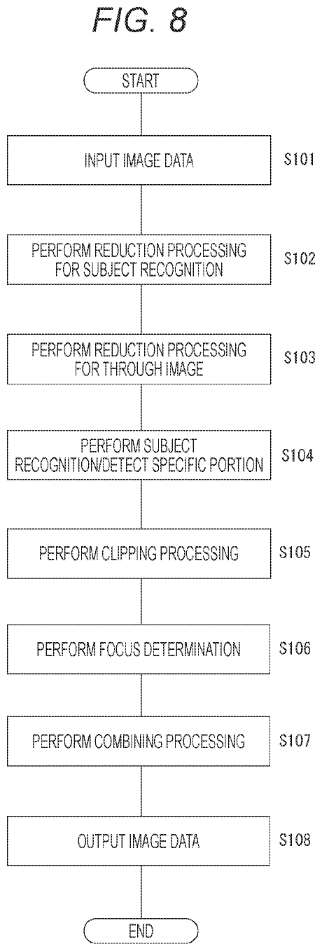

The configuration of the image processing device 1 as illustrated in FIG. 5 can be achieved as software in a DSP or a microcomputer. For example, by a program that causes an arithmetic processing device to execute the processing illustrated in FIG. 8, the arithmetic processing device is implemented as the image processing device 1 of the embodiment.

Processing of FIG. 8 of the image processing device 1 based on such a program will be described.

The processing of FIG. 8 is performed, for example, for each frame of the input image data Din. In step S101, the image processing device 1 acquires input image data Din of one frame.

In step S102, the image processing device 1 performs reduction processing for subject recognition processing on the input image data Din. This processing is, namely, the processing of the image reduction unit 10 described above.

In step S103, the image processing device 1 performs reduction processing for generating the through image data Dthr on the input image data Din. This processing is, namely, the processing of the image reduction unit 14 described above.

In step S104, the image processing device 1 performs processing of the image recognition unit 11. That is, the image processing device 1 performs image analysis of the current frame, performs the subject recognition processing, and detects the specific portion of the subject. For example, the right eye is detected as the specific portion, and the coordinate position of the specific portion is specified.

In step S105, the image processing device 1 performs processing of the image clipping unit 13. That is, the image processing device 1 sets a clipping region on the basis of the coordinate position of detected one or more specific portions, and executes the clipping processing from the input image data Din. Thus, one or more pieces of the clipped image data Dc are obtained.

In step S106, the image processing device 1 performs processing of the focus determination unit 18. That is, the image processing device 1 performs the above-described cepstrum calculation on one or more pieces of the clipped image data Dc, and generates the in-focus determination information FI.

In step S107, the image processing device 1 performs processing of the image combining unit 15. That is, the image processing device 1 performs processing of combining the through image data Dthr and an image based on the in-focus determination information FI of one or more pieces of the clipped image data Dc, for example, an image of the in-focus determination value 35, the in-focus determination bar 36, or the like, and generates combined image data Dm.

Then, in step S108, the combined image data Dm is output.

By the above processing, image display as illustrated in FIGS. 6 and 7 is performed on the display device, and the user can perform manual focus operation while checking the through image 30 and the degree of in-focus.

### 3. Second Embodiment

In the first embodiment described above, the calculation of the cepstrum of the eye region is performed by Fourier transform. Here, the size of the eye region in the image greatly changes depending on the distance between the imaging device 100 and the person, or the like. Then, when a region other than the eye enters the target of the Fourier transform, the calculated cepstrum may be adversely affected.

Accordingly, as a second embodiment, it is conceivable to estimate the size of the eye at a distance from both eyes or other parts and change the image size used for Fourier transform, that is, the clipping region of the clipped image data Dc in the processing of detecting the specific portion in the image analysis.

Specifically, when the eyes are large, the image size is increased, and when the eyes are small, the image size is decreased. In this manner, it is possible to prevent images other than the eyes from entering the clipped image data Dc, and it is possible to improve the accuracy of the calculated cepstrum.

Alternatively, a window size of a window function used in the FFT often used in the Fourier transform in image processing may be adjusted, and the window function in which only the eye region is included may be applied.

### 4. Third Embodiment

In the first embodiment, the PSF for not being in focus or what is called out of focus is estimated. However, the blur includes not only the out of focus but also a motion blur. The motion blur means that an object as an imaging target moves sufficiently fast with respect to a shutter interval of the camera, so that the captured image is blurred like flowing in the direction of the motion of the object as the imaging target. The use of the cepstrum described in the first embodiment does not make it impossible to detect the motion blur, but in a case where the out of focus and the motion blur occur at the same time, it is difficult to separate the out of focus and the motion blur.

Accordingly, when the object is moving, it is made possible to clearly indicate that the reliability of the in-focus determination information FI which is a result of digitizing the degree of in-focus is low.

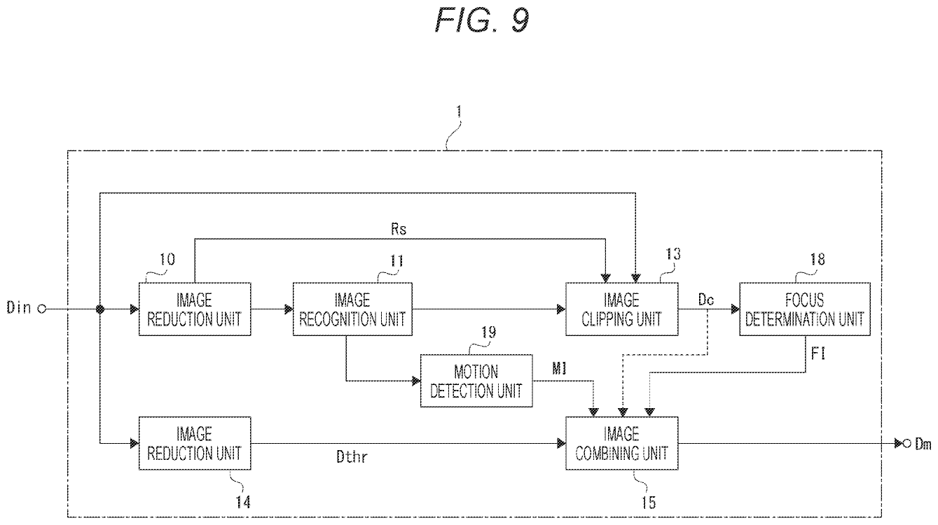

Specifically, as illustrated in FIG. 9, the image processing device 1 includes a motion detection unit 19.

The motion detection unit 19 calculates the movement amount of an eye region by using the position coordinates of the specific portion (for example, the eye) of the subject detected by the image recognition unit 11, an image in which the position of the eye is detected, and an image captured one frame before, for example. For example, by using a method called block matching, the movement amount of the eye region can be calculated.

Then, it is determined whether or not a motion of the specific portion is at a certain speed or more, and a determination result is output as motion detection information MI.

The image combining unit 15 switches the content of the combining processing according to the motion detection information MI.

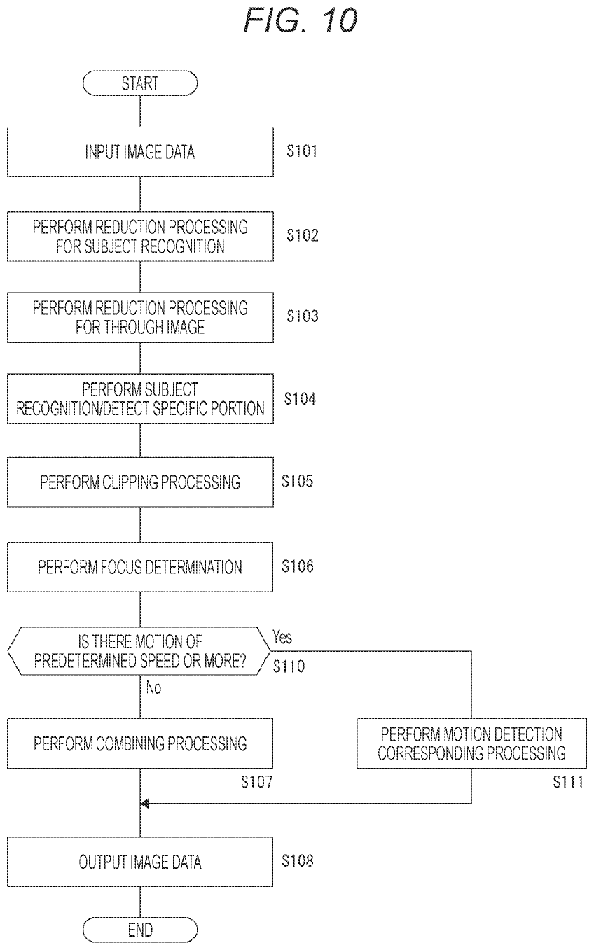

FIG. 10 illustrates a processing example. Note that processes similar to those in FIG. 8 are denoted by the same step numbers, and redundant description is avoided.

The image processing device 1 checks the motion detection information MI in step S110, and checks whether or not there is a predetermined motion or more with respect to the specific portion of the subject, that is, a portion to be displayed based on the in-focus determination information FI.

In a case where it is determined that there is no motion for all specific portions, in step S107, the image processing device 1 performs processing of combining the through image data Dthr and an image based on the in-focus determination information FI of one or more pieces of the clipped image data Dc, for example, an image such as the in-focus determination value 35 or the in-focus determination bar 36, and generates the combined image data Dm.

Then, in step S108, the combined image data Dm is output. Therefore, image display as illustrated in FIGS. 6 and 7 is performed on the display device.

On the other hand, in a case where it is determined that there is a motion at a predetermined speed or more with respect to a part or all of one or more specific portions, image combining as motion detection corresponding processing is performed in step S111.

Then, in step S108, the combined image data Dm is output.

As the combining processing as the motion detection corresponding processing in this case, the following example can be considered.

For example, it is assumed that an image based on the in-focus determination information FI is not displayed for the specific portion where a motion at the predetermined speed or more is detected.

For example, when the in-focus determination information FI is calculated for each of three specific portions, in a case where it is determined that there is a motion at the predetermined speed or more in a specific portion corresponding to one piece of the in-focus determination information FI, display of the in-focus determination value 35 and the like based on other two pieces of the in-focus determination information FI is performed, but display of the in-focus determination value 35 and the like is turned off for the specific portion in motion.

Furthermore, for example, in a case where it is determined that there is a motion at the predetermined speed or more in all the specific portions when the in-focus determination information FI is calculated for each of the three specific portions, display of the in-focus determination value 35 or the like based on the three pieces of the in-focus determination information FI is not performed. That is, the combining processing is not performed.

Furthermore, it is also conceivable to perform display indicating that the display of the image based on the in-focus determination information FI has low reliability for the specific portion where a motion at the predetermined speed or more has been detected.

For example, for the specific portion determined to be in motion at the predetermined speed or more, display of the in-focus determination value 35 or the like based on the in-focus determination information FI is performed, but a text, an icon, or the like indicating low reliability is displayed so that the user recognizes the low reliability.

Alternatively, the low reliability may be presented in such a manner that the color of the in-focus determination value 35 or the like is changed, the gradation is changed and thinned, or the luminance is lowered.

In addition, a message indicating the low reliability may be displayed.

By doing so, the user can recognize that the reliability of the display indicating the degree of in-focus, such as the in-focus determination value 35 and the in-focus determination bar 36, is low for the specific portion in motion, and can determine that manual focus operation that does not depend on the display should be temporarily performed. Consequently, it becomes a guide for properly performing the manual focus operation.

### 5. Fourth Embodiment

The numerical value of the degree of in-focus based on the cepstrum described in the first embodiment expresses an approximate degree of blurring, but it cannot be said to be a strict value because some influence of the original image data remains. Thus, there is a possibility that it is difficult for the user to achieve a completely focused state only by looking at an absolute value as a numerical value such as the in-focus determination value 35. That is, there may be an influence of the cepstrum of the original image data regarded as a constant.

However, if the same eye region is captured, the cepstrum of the original image data is the same, and thus the cepstrum of the input image data as the processing target depends only on the cepstrum of the PSF. Therefore, it can be said that it is possible to see the time displacement of the PSF.

Accordingly, it is conceivable to retain the in-focus determination information FI obtained by digitizing the degree of in-focus for a certain period of time, and display a variation state such as whether the numerical value is improved or deteriorated within the retention time.

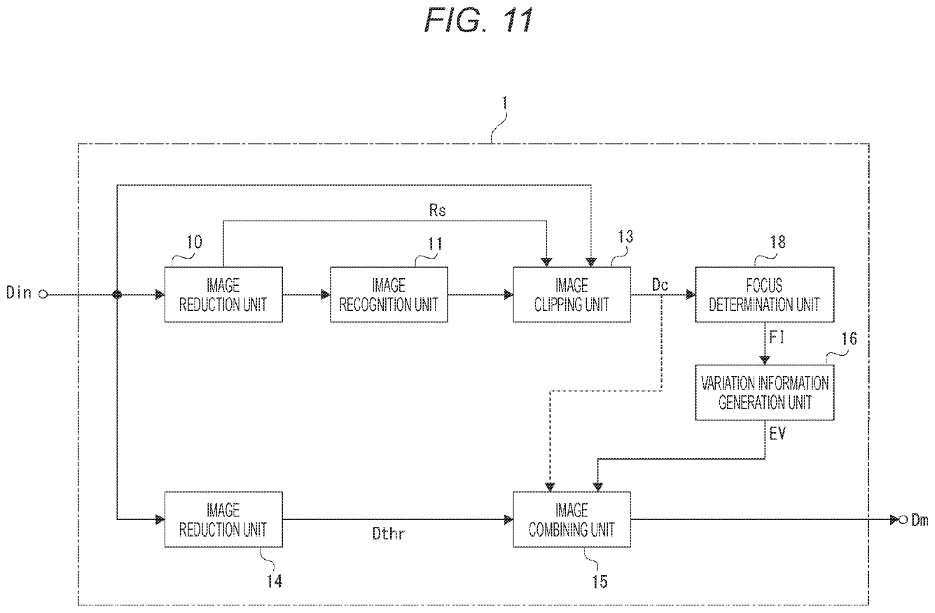

For example, as illustrated in FIG. 11, a variation information generation unit 16 that receives an input of the in-focus determination information FI from the focus determination unit 18 is provided.

The variation information generation unit 16 stores the in-focus determination information FI calculated for the specific portion for each frame of the input image data Din, for example, in a ring memory form for a certain period of time.

Then, for example, the certain period of retention time is divided into the first half and the second half, and respective average values of the in-focus determination information FI are calculated. Then, the respective average values of the first half and the second half are compared, and if the first half is smaller, it is evaluated as proceeding in a direction to be in focus, and if the first half is larger, it is evaluated as proceeding in a direction to be out of focus. Then, focus variation information EV indicating whether the focus is varying in the direction to be in focus or varying in the direction to be out of focus is transmitted to the image combining unit 15.

The image combining unit 15 performs processing of generating image data based on the focus variation information EV and combining the image data with the through image data Dthr.

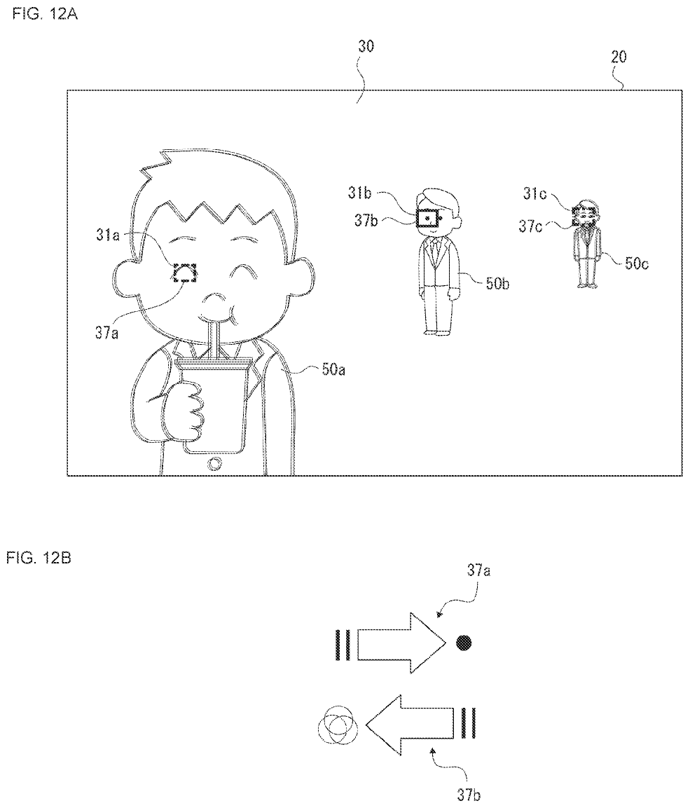

Thus, for example, the display as illustrated in FIG. 12A is executed.

In FIG. 12A, respective eyes of the persons 50a, 50b, and 50c are set as specific portions, and focus frames 31 are displayed, but the focus frames 31 are used as focus variation images 37.

A focus variation image 37a (focus frame 31a) of the person 50a is indicated by a broken line, and is assumed to be, for example, a red frame image.

A focus variation image 37b (focus frame 31b) of the person 50b is indicated by a solid line, and is assumed to be, for example, a green frame image.

A focus variation image 37c (focus frame 31c) of the person 50c is indicated by a one-dot chain line, and is assumed to be, for example, a blue frame image.

For example, a variation in the direction to be in focus is indicated by blue, and a variation in the direction to be out of focus is indicated by red. In a case where the change from the in-focus state is small, it is indicated in green.

That is, when a temporal variation of the degree of in-focus is a variation in which the degree of in-focus increases and is evaluated to be approaching the in-focus state, it is indicated by blue, and when the temporal variation of the degree of in-focus is a variation in which the degree of in-focus decreases and is evaluated to be moving away from the in-focus state, it is indicated by red. In a case where the absolute value of the amount of variation from the in-focus state is equal to or less than a predetermined value and can be evaluated to be substantially the in-focus state, it is indicated by green.

Then, when the manual focus operation is started in the far direction from the situation where the user is focused on the person 50b, such a display is performed.

Thus, the subject in focus and the subjects in a direction approaching focus and in a direction away from focus by the manual focus operation are expressed.

Note that, although the focus frame 31 is used as the focus variation image 37 as an example here, the focus variation direction may be expressed by displaying the in-focus determination value 35 described with reference to FIG. 6, and changing the color of the in-focus determination value 35 as the focus variation image 37.

Furthermore, as illustrated in FIG. 12B, the focus variation direction may be presented by displaying a focus variation image 37a indicating approaching focus or a focus variation image 37b indicating a direction away from focus near the focus frame 31, or the like.

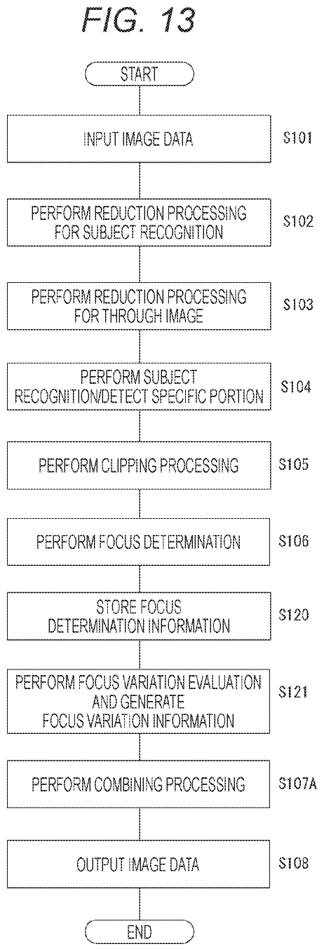

FIG. 13 illustrates a processing example. Steps S101 to S106 are similar to those in FIG. 8, and duplicate description is avoided.

The image processing device 1 performs the processing of the variation information generation unit 16 in steps S120 and S121. In step S120, the image processing device 1 stores the in-focus determination information FI of the current frame. Then, in step S121, the image processing device 1 determines the focus variation direction for each specific portion using the in-focus determination information FI stored for a certain period of time, and generates the focus variation information EV.

In step S107A, the image processing device 1 generates image data based on the focus variation information EV for one or more specific portions, combines the image data with the through image data Dthr, and outputs combined the combined image data Dm in step S108.

Thus, for example, image display as illustrated in FIG. 12A is performed in the display device.

In this manner, since the focus variation direction by the manual focus operation is clearly indicated, it is easy for the user to understand in which direction of far or near to perform the focus operation on the target subject.

### 6. Fifth Embodiment

Although the in-focus determination value 35 (the numerical value of the in-focus determination information FI) described in the first embodiment expresses an approximate degree of blurring, it cannot be said that it is a strict value because some influence of the original image remains. Thus, there is a possibility that it is difficult to achieve a completely focused state only by looking at the absolute value of the numerical value.

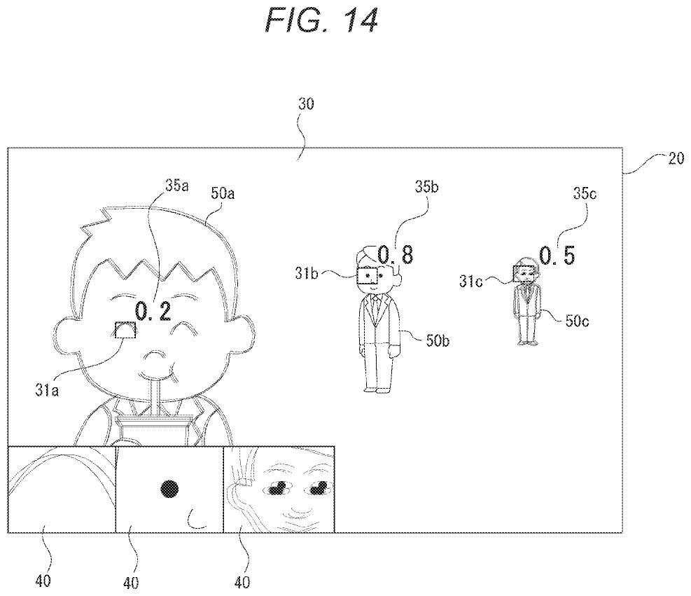

Accordingly, as illustrated in FIG. 14, it is conceivable that the final focusing can be visually checked by combining the clipped image 40 having a higher resolution with the through image 30 and displaying the combined image.

Specifically, as indicated by a broken line in FIG. 5, the clipped image data Dc for one or more specific portions is sent to the image combining unit 15. The image combining unit 15 combines an image (in-focus determination value 35) based on the in-focus determination information FI with the through image data Dthr, and also performs the combining processing of the clipped image data Dc to generate the combined image data Dm.

Thus, it is possible to achieve display in which the clipped image 40 is superimposed and combined on the through image 30 as illustrated in FIG. 14. Of course, the through image 30 and the clipped image 40 may be divided into areas in one screen and shown.

Also in the case of the configurations of FIGS. 9 and 11, the clipped image data Dc may be sent to the image combining unit 15 and combined as indicated by a broken line.

The clipped image data Dc is an image obtained by clipping around the specific portion from the input image data Din, and has a higher resolution than the through image data Dthr. Therefore, the user can finely check the focus state by the clipped image 40, and it becomes easy to finely adjust the focus state.

In particular, in a case where the resolution of the display device is lower than the resolution of the captured image data (input image data Din), the through image data Dthr is generated by performing the reduction processing, and the through image 30 is displayed. Thus, it may be difficult for the user to understand a fine focus state only with the through image 30. Even under such a situation, since the clipped image 40 is clipped with the resolution of the input image data Din, it is easy to perform visual checking at the time of the focus operation.

### 7. Sixth Embodiment

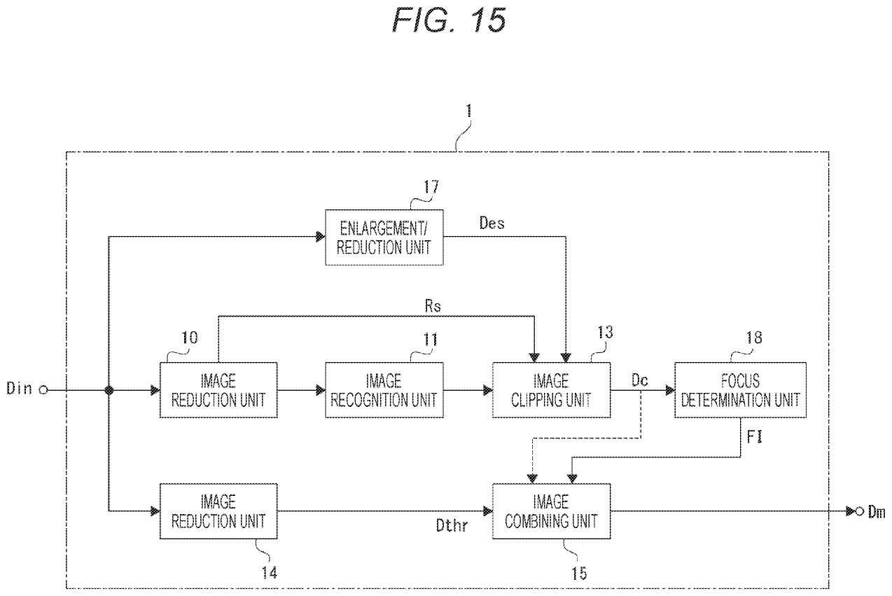

FIG. 15 illustrates a configuration example of the image processing device 1 of a sixth embodiment. This is obtained by adding an enlargement-reduction unit 17 to the above-described configuration of FIG. 5.

The enlargement-reduction unit 17 performs enlargement processing or reduction processing on the input image data Din. Then, enlarged or reduced image data Des is supplied to the image clipping unit 13. The image clipping unit 13 performs the clipping processing on image data Des to generate the clipped image data Dc.

In this case, as the reduction processing, the resolution of the input image data Din is reduced, but this reduction ratio is made smaller than the reduction ratio to the through image data Dthr by the image reduction unit 14. That is, it is assumed that the image data Des has a higher resolution than the through image data Dthr.

Thus, in a case where the clipped image 40 is displayed as illustrated in FIG. 14, it is possible to maintain that the clipped image 40 has a resolution higher than that of the through image 30, and it is possible to obtain an image suitable for checking the focus state.

Furthermore, by maintaining the resolution of the clipped image 40 at a certain level or higher, the calculation of the in-focus determination information FI in the focus determination unit 18 can also maintain high accuracy.

The enlargement-reduction unit 17 may generate the image data Des in which the resolution of the input image data Din is further increased by, for example, a super-resolution technology or the like.

In this case, it is possible to display the clipped image 40 with higher definition.

### 8. Summary and Modification Example

In the above embodiments, the following effects can be obtained.

The image processing device 1 of the first to sixth embodiments includes the focus determination unit 18 that generates the in-focus determination information FI obtained by digitizing the degree of in-focus for the specific portion of the subject included in the input image data Din.

For example, by generating, as the in-focus determination information FI, a value obtained by digitizing the degree of in-focus, in other words, the degree of blur for a specific portion such as human eyes, it is possible to provide the user with information visualizing the degree of in-focus. For example, by displaying for assisting the focus operation of the user, information useful for the user can be provided.

Note that, for example, by setting the “right eye” of the subject person as the specific portion and setting the same part for a plurality of subject persons as the specific portion, it is easy to compare the degree of in-focus for each subject person. This is because the specific portion to be a material for calculating the in-focus determination information is common. However, sometimes “right eye” cannot be detected in a state where a certain person is facing sideways, or the like, and in this case, the in-focus determination information may be generated on the basis of another specific portion. For example, from the face parts, the specific portion may be set in priority order such as right eye, left eye, right ear, left ear, mouth, and nose.

In a case where a plurality of persons is subjects, it is desirable to set a common part as the “specific portion” as much as possible, but another part (for example, an ear) may be set as the specific portion for some of the subject persons. In addition, the “specific portion” may be different depending on a person, an animal, an object, or the like.

The image processing device 1 of the first to sixth embodiments includes the image combining unit 15 that performs combining processing in which an image based on the in-focus determination information FI is combined with an image based on the input image data Din and displayed.

By making it possible to display an image in which the degree of in-focus is visualized for the specific portion such as human eyes by the combining processing, for example, when the user performs manual focus operation, the user can perform the operation depending on the display content, and it is possible to support visual checking of manual focus.

The image based on the input image data Din may be the input image data Din itself or the through image 30 obtained by reducing the resolution of the input image data Din. In addition, an image in which the resolution of the input image data Din is increased may be used, or an image obtained by clipping a part of the input image data Din may be used.

The image combining unit 15 of the embodiment combines the through image data Dthr obtained by reducing the resolution of the input image data Din and the image data based on the in-focus determination information FI.

By generating the combined image data Dm obtained by combining the through image data Dthr and the image data based on the in-focus determination information FI and displaying the combined image data Dm on the display device, an image expressing the degree of in-focus can be visually recognized on the through image 30. The user can check an in-focus state of the specific portion to be focused while viewing the through image 30.

An example has been described in which the image combining unit 15 of the embodiment performs combining processing in which a numerical value image based on the in-focus determination information FI is displayed in association with the specific portion.

For example, by displaying the in-focus determination value 35 as a numerical value image based on the degree of in-focus as illustrated in FIG. 6 on the through image 30, the user can clearly know the degree of in-focus by the numerical value, and it becomes an appropriate guide for manual focus operation.

The displayed numerical value may be the value itself of the combining determination information or a value obtained by normalizing the combining determination information. In addition, a value such as a level value when the degree of in-focus is converted into levels on the basis of the combining determination information may be used.

In the embodiment, an example has been described in which the image combining unit 15 performs the combining processing in which an image representing the in-focus determination information FI by a shape, a color, a luminance, or a gradation is displayed in association with the specific portion.

For example, by displaying the in-focus determination bar 36 having a length corresponding to the in-focus determination information FI as illustrated in FIG. 7 on the through image 30, the user can intuitively know the degree of in-focus by its shape (the length of the in-focus determination bar 36), and it becomes an appropriate guide for manual focus operation.

Note that the example of FIG. 7 is not limited to the in-focus determination bar 36, and examples of other shapes such as a circular graph display are also conceivable. In addition, a display that expresses a value of the in-focus determination information by a change in gradation, luminance, color, size, or the like of an image such as a figure or an icon, or a composite change thereof may be used. Moreover, display may be performed to express the value of the in-focus determination information by a color, a luminance, or a gradation of the specific portion itself. By indicating the degree of in-focus by these graphical displays, it is possible to make it easy for the user to intuitively understand.

In the embodiment, an example has been described in which the image combining unit 15 performs the combining processing so that the image based on the in-focus determination information FI is combined and displayed near the specific portion in the image based on the input image data Din (for example, in the through image 30).

For example, by displaying the image based on the in-focus determination information near the eye that is the specific portion (near the focus frame 31 displayed for the eye) as illustrated in FIG. 6, when the user views the through image 30, it is possible to quite easily grasp which specific portion has what degree of in-focus.

Note that, in the example of FIG. 6, the in-focus determination value 35 is displayed near the focus frame 31 indicating the specific portion, but the in-focus determination value 35 or the like may be displayed apart from the focus frame 31. In the example of FIG. 7, the focus frame 31 indicating the specific portion and the in-focus determination bar 36 are displayed apart from each other.

Even in a case of being displayed apart from each other as described above, for example, it is sufficient if the correspondence relationship can be checked by, for example, making the color of the focus frame 31 the same as the color of the corresponding in-focus determination value 35, or the like, so that it is clear which focus frame 31 each in-focus determination value 35 is for. For example, in a case where the screen becomes troublesome if the image based on the in-focus determination information is displayed near the specific portion, it is preferable to display the image separately.

Considering this, it is also useful to enable the user to switch between a display mode in which the image based on the in-focus determination information is displayed near the specific portion and a mode in which the image based on the in-focus determination information is displayed separately from the specific portion, and to enable the user to select a display state according to a use case or preference.

The third embodiment has described that the motion detection unit 19 that detects a motion of the specific portion is provided, and the image combining unit 15 changes the display state of the image based on the in-focus determination information FI according to the motion detection result of the motion detection unit 19 for the corresponding specific portion.

In a case of a subject in motion, what is called a motion blur occurs, which lowers the reliability of the in-focus determination information FI. Thus, by changing the display state, a display state suitable for a case where there is a motion is obtained.

In the third embodiment, an example has been described in which the image combining unit 15 turns off the display of the image based on the in-focus determination information for the specific portion in which the motion at the predetermined speed or more is detected by the motion detection unit 19. That is, on/off of display of an image representing the in-focus determination information FI is switched according to the presence or absence of a motion for the specific portion.

In a case where the reliability of the in-focus determination information FI decreases due to a motion at the predetermined speed or more, it is possible not to display an image representing the in-focus determination information FI for the specific portion, thereby not to present information that cannot ensure the reliability to the user.

Note that not all of the specific portions in the through image 30 are in motion. In a case where there is a motion in only a part of the plurality of specific portions, it is sufficient if an image representing the in-focus determination information FI is displayed for a specific portion having no motion (motion speed is less than a predetermined speed).

In the third embodiment, an example has also been described in which the image combining unit 15 changes the display mode of the image based on the in-focus determination information FI for the specific portion where a motion at the predetermined speed or more is detected by the motion detection unit 19. For example, the color, the luminance, the gradation, the size, the shape, and the like of the image representing the in-focus determination information FI are changed according to the presence or absence of a motion for the specific portion.

In a case where the reliability of the in-focus determination information FI decreases due to a motion at the predetermined speed or more, it is possible to notify the user that the reliability of the image cannot be secured by changing the display mode of the image expressing the in-focus determination information FI for the specific portion.

In the fourth embodiment, an example has been described in which the variation information generation unit 16 that generates the focus variation information EV indicating the temporal variation of the degree of in-focus on the basis of the in-focus determination information FI is provided, and the image combining unit 15 performs the combining processing in which the image based on the focus variation information EV is combined with the image (for example, the through image 30) based on the input image data Din and displayed.

Whether the specific portion is changed in the direction to be in focus or in the direction to be blurred by the manual focus operation of the user is clearly indicated by the focus variation image 37. This provides a preferable guide for manual focus operation. This is because the user is only required to perform an operation so that the focus variation image 37 indicates the direction to be in focus on the target subject. This is also useful in place of the display indicating the degree of in-focus as in the first embodiment.

In particular, the display form of the image based on the focus variation information EV is made different between a case of a variation approaching focus and a case of a variation moving away from focus. Moreover, even in a case where the temporal variation of the degree of in-focus from the in-focus state is equal to or less than a predetermined value, a display form different from the above is set. Such a difference in display form makes it easy to recognize the focus variation.

In the fourth embodiment, an example has been described in which the image based on the focus variation information EV is an image indicating the temporal variation of the degree of in-focus according to a shape, a color, or a gradation.

As in the example of FIG. 12, the variation in the focus state is indicated by a shape, a color, a luminance, a gradation, or a combination thereof, so that the user can intuitively recognize whether a transition is made in a direction to be in focus on each specific portion or a transition is made in a direction to be blurred by the manual focus operation, and the operability is improved.

In the fifth embodiment, an example has been described in which the image combining unit 15 performs the combining processing in which the clipped image 40 including the specific portion is combined with the image (for example, the through image 30) based on the input image data Din.

By combining the clipped image data Dc, the through image and the clipped image 40 can be simultaneously viewed on one screen as illustrated in FIG. 14. The user can finely check the focus state for the key point with the clipped image 40 while checking the subject side with the through image 30. Therefore, while the degree of in-focus is recognized by the in-focus determination value 35, the actual image state can also be checked more precisely by the clipped image 40.

Of course, in a case where an image based on the in-focus determination information is displayed by the in-focus determination bar 36 as illustrated in FIG. 7 or another shape, color, luminance, or size, the clipped image 40 may also be displayed.

Moreover, as in the third embodiment, in a case where the display state is switched according to the motion detection, the clipped image 40 may be displayed.

Furthermore, as in the fourth embodiment, the clipped image 40 may be displayed together with the focus variation image 37 based on the focus variation information EV.

In either case, the state of the actual image can be checked with the clipped image 40 in addition to guidance by the display based on the in-focus determination information and the focus variation information.

In the fifth embodiment, an example has been described in which the image based on the input image data Din with which the clipped image 40 is combined is the through image 30 obtained by reducing the resolution of the input image data Din.

In this case, the clipped image 40 is an image having a higher resolution than the through image 30. Therefore, the focus state of the clipped image 40 is easier to check than the through image 30, and the clipped image 40 is preferable as an image for focus assist.

The in-focus determination information FI in the embodiment is information based on information obtained by converting image data into a frequency space, logarithmically converting a power spectrum in the frequency space, and further performing an inverse Fourier transform of the power spectrum. The in-focus determination information FI based on what is called a cepstrum is obtained.

In a case of a specific portion such as an eye, since the cepstrum is effective information for digitizing the degree of blurring, highly reliable in-focus determination information can be obtained on the basis of the information.

As described in the first embodiment, the image recognition unit 11 performs the subject recognition processing using the image data in which the resolution of the input image data Din is reduced by the image reduction unit 10.

Thus, the processing load of the subject recognition processing can be reduced. In particular, in a case where the input image data Din is a high definition image such as 8K or 4K, the analysis processing load is heavy as it is, and the subject recognition processing with high accuracy can be performed even if the resolution is reduced to, for example, about 2K. Accordingly, it is desirable to reduce the resolution by the image reduction unit 10.

Note that the image recognition unit 11 may perform the subject recognition processing without reducing the input image data Din. In a case where the processing capability of the image recognition unit 11 is high, subject recognition accuracy can be improved by performing the subject recognition processing on an image with higher resolution.

The program of the embodiment is, for example, a program for causing a CPU, a DSP, or a device including the CPU, the DSP, or the like to execute the processing illustrated in FIG. 8, FIG. 10, or FIG. 13.

That is, the program of the embodiment is a program that causes the arithmetic processing device to execute processing of generating the in-focus determination information FI obtained by digitizing the degree of in-focus for the specific portion of the subject included in the input image data Din.

With such a program, the image processing device 1 of the present disclosure can be easily achieved using an arithmetic processing device.

Such a program can be recorded in advance in a hard disk drive (HDD) as a recording medium built in a device such as a computer device, a ROM in a microcomputer having a CPU, or the like.

Alternatively, the program can be temporarily or permanently stored (recorded) in a removable recording medium such as a flexible disk, a compact disc read only memory (CD-ROM), a magneto optical (MO) disk, a digital versatile disc (DVD), a Blu-ray disc (registered trademark), a magnetic disk, a semiconductor memory, or a memory card. Such a removable recording medium can be provided as what is called package software.

Furthermore, such a program can be installed from the removable recording medium into a personal computer or the like, or can be downloaded from a download site via a network such as a local area network (LAN) or the Internet.

Note that effects described in the present description are merely examples and are not limited, and other effects may be provided.

Note that the present technology can employ configurations as follows.
(1)

An image processing device, including:
a focus determination unit that generates in-focus determination information obtained by digitizing a degree of in-focus for a specific portion of a subject included in input image data.
(2)

The image processing device according to (1) above, further including:
an image combining unit that performs combining processing in which an image based on the in-focus determination information is combined with an image based on the input image data and displayed.
(3)

The image processing device according to (2) above, in which
the image combining unit
combines through image data obtained by reducing a resolution of the input image data and image data based on the in-focus determination information.
(4)

The image processing device according to (2) or (3) above, in which
the image combining unit
performs combining processing in which a numerical value image based on the in-focus determination information is displayed in association with the specific portion.
(5)

The image processing device according to any one of (2) to (4) above, in which
the image combining unit
performs combining processing in which an image representing the in-focus determination information by a shape, a color, a luminance, or a gradation is displayed in association with the specific portion.
(6)

The image processing device according to any one of (2) to (5) above, in which
the image combining unit
performs combining processing in which the image based on the in-focus determination information is combined and displayed near the specific portion in the image based on the input image data.
(7)

The image processing device according to any one of (2) to (6) above, further including:
a motion detection unit that detects a motion of the specific portion, in which
the image combining unit
changes a display state of the image based on the in-focus determination information according to a motion detection result of the motion detection unit for the corresponding specific portion.
(8)

The image processing device according to (7) above, in which
the image combining unit
turns off display of the image based on the in-focus determination information for the specific portion in which the motion detection unit detects a motion at a predetermined speed or more.
(9)

The image processing device according to (7) above, in which
the image combining unit
changes a display mode of the image based on the in-focus determination information for the specific portion in which the motion detection unit detects a motion at a predetermined speed or more.
(10)

The image processing device according to any one of (1) to (9) above, further including:
a variation information generation unit that generates focus variation information indicating a temporal variation of a degree of in-focus on the basis of the in-focus determination information; and
an image combining unit that performs combining processing in which an image based on the focus variation information is combined with an image based on the input image data and displayed.
(11)

The image processing device according to (10) above, in which
the image based on the focus variation information is an image indicating the temporal variation of the degree of in-focus by a shape, a color, a luminance, or a gradation.
(12)

The image processing device according to (10) or (11) above, in which
in the image based on the focus variation information,
a display form is made different between when a temporal variation of a degree of in-focus is a variation approaching focus and when the temporal variation is a variation moving away from focus.
(13)

The image processing device according to (12) above, in which
in a case where the temporal variation of the degree of in-focus from an in-focus state is equal to or less than a predetermined value, the image based on the focus variation information is in a display form different from a display mode in a case where the temporal variation is a variation approaching focus and a display mode in a case where the temporal variation is a variation moving away from focus.
(14)

The image processing device according to any one of (2) to (13) above, in which
the image combining unit performs combining processing in which a clipped image including the specific portion is combined with the image based on the input image data.
(15)

The image processing device according to (14) above, in which
the image based on the input image data is a through image obtained by reducing a resolution of the input image data, and
the clipped image is an image having a higher resolution than the through image.
(16)

The image processing device according to any one of (1) to (15) above, in which
the in-focus determination information
is information based on information obtained by converting image data into a frequency space, logarithmically converting a power spectrum in the frequency space, and further performing an inverse Fourier transform of the power spectrum.
(17)

An image processing method, including:
by an image processing device,
performing processing of generating in-focus determination information obtained by digitizing a degree of in-focus for a specific portion of a subject included in input image data.
(18)

A program to be executed by an arithmetic processing device
processing of generating in-focus determination information obtained by digitizing a degree of in-focus for a specific portion of a subject included in input image data.

### REFERENCE SIGNS LIST

1 Image processing device
6 Display device
7 Control unit
10, 14 Image reduction unit
11 Image recognition unit
13 Image clipping unit
15 Image combining unit
16 Variation information generation unit
17 Enlargement-reduction unit
18 Focus determination unit
19 Motion detection unit
20 Screen
30 Through image
31, 31a, 31b, 31c Focus frame
35a, 35b, 35c, In-focus determination value
36, 36a, 36b, 36c, In-focus determination bar
37, 37a, 37b Focus variation image
40 Clipped image

1. An image processing device, comprising:
a focus determination unit that generates in-focus determination information obtained by digitizing a degree of in-focus for a specific portion of a subject included in input image data.

2. The image processing device according to claim 1, further comprising:
an image combining unit that performs combining processing in which an image based on the in-focus determination information is combined with an image based on the input image data and displayed.

3. The image processing device according to claim 2, wherein
the image combining unit
combines through image data obtained by reducing a resolution of the input image data and image data based on the in-focus determination information.

4. The image processing device according to claim 2, wherein
the image combining unit
performs combining processing in which a numerical value image based on the in-focus determination information is displayed in association with the specific portion.

5. The image processing device according to claim 2, wherein
the image combining unit
performs combining processing in which an image representing the in-focus determination information by a shape, a color, a luminance, or a gradation is displayed in association with the specific portion.

6. The image processing device according to claim 2, wherein
the image combining unit
performs combining processing in which the image based on the in-focus determination information is combined and displayed near the specific portion in the image based on the input image data.

7. The image processing device according to claim 2, further comprising:
a motion detection unit that detects a motion of the specific portion, wherein
the image combining unit
changes a display state of the image based on the in-focus determination information according to a motion detection result of the motion detection unit for the corresponding specific portion.

8. The image processing device according to claim 7, wherein
the image combining unit
turns off display of the image based on the in-focus determination information for the specific portion in which the motion detection unit detects a motion at a predetermined speed or more.

9. The image processing device according to claim 7, wherein
the image combining unit
changes a display mode of the image based on the in-focus determination information for the specific portion in which the motion detection unit detects a motion at a predetermined speed or more.

10. The image processing device according to claim 1, further comprising:
a variation information generation unit that generates focus variation information indicating a temporal variation of a degree of in-focus on a basis of the in-focus determination information; and
an image combining unit that performs combining processing in which an image based on the focus variation information is combined with an image based on the input image data and displayed.

11. The image processing device according to claim 10, wherein
the image based on the focus variation information is an image indicating the temporal variation of the degree of in-focus by a shape, a color, a luminance, or a gradation.

12. The image processing device according to claim 10, wherein
in the image based on the focus variation information,
a display form is made different between when a temporal variation of a degree of in-focus is a variation approaching focus and when the temporal variation is a variation moving away from focus.

13. The image processing device according to claim 12, wherein
in a case where the temporal variation of the degree of in-focus from an in-focus state is equal to or less than a predetermined value, the image based on the focus variation information is in a display form different from a display mode in a case where the temporal variation is a variation approaching focus and a display mode in a case where the temporal variation is a variation moving away from focus.

14. The image processing device according to claim 2, wherein
the image combining unit performs combining processing in which a clipped image including the specific portion is combined with the image based on the input image data.

15. The image processing device according to claim 14, wherein
the image based on the input image data is a through image obtained by reducing a resolution of the input image data, and
the clipped image is an image having a higher resolution than the through image.

16. The image processing device according to claim 1, wherein
the in-focus determination information
is information based on information obtained by converting image data into a frequency space, logarithmically converting a power spectrum in the frequency space, and further performing an inverse Fourier transform of the power spectrum.

17. An image processing method, comprising:
by an image processing device,
performing processing of generating in-focus determination information obtained by digitizing a degree of in-focus for a specific portion of a subject included in input image data.

18. A program for causing an arithmetic processing device to execute:
processing of generating in-focus determination information obtained by digitizing a degree of in-focus for a specific portion of a subject included in input image data.
